(19) United States
(12) Patent Application Publication
(10) Pub. No.: US 2017/0245119 A1
(43) Pub. Date: Aug. 24, 2017

(54) MULTICAST SERVICE SETUP

(71) Applicants: Po-Kai Huang, West Lafayette, IN (US); Elad Oren, Tel Aviv (IL); Emily H. Qi, Portland, OR (US)

(72) Inventors: Po-Kai Huang, West Lafayette, IN (US); Elad Oren, Tel Aviv (IL); Emily H. Qi, Portland, OR (US)

(21) Appl. No.: 15/192,566

(22) Filed: Jun. 24, 2016

Related U.S. Application Data
(60) Provisional application No. 62/298,062, filed on Feb. 22, 2016.

(51) Int. Cl. H04W 4/06

(52) U.S. Cl. CPC H04W 4/06; H04L 12/189

(57) ABSTRACT

A multicast publisher and method of establishing multicast scheduling are provided. The publisher determines a schedule for a multicast service that is selected from time slots of a schedule candidate. The schedule candidate is set by the publisher that initiates the multicast group. The multicast group is one-to-many or many-to-many. A response to a request for the service is transmitted to a subscriber and contains the multicast schedule. The response indicates whether the service is available for unicast transmission in addition to multicast. A schedule selection policy for other multicast publishers joining the multicast group specifies that the other multicast publishers are to follow the multicast schedule acquired when joining the multicast group, use the multicast schedule candidate to determine a multicast schedule, or are free to choose a multicast schedule.

### PRIORITY CLAIM

This application claims the benefit of priority under 35 U.S.C. 119(e) to U.S. Provisional Patent Application Ser. No. 62/298,062, filed Feb. 22, 2016, and entitled “MULTICAST SERVICE SETUP,” which is incorporated herein by reference in its entirety.

### TECHNICAL FIELD

Embodiments pertain to wireless communications. Some embodiments relate to wireless local area networks (WLANs) and Wi-Fi networks including networks operating in accordance with the IEEE 802.11 family of standards. Some embodiments relate to multicast service setup in a Wi-Fi alliance Wi-Fi Aware 2.0 Neighborhood Awareness Network (NAN).

### BACKGROUND

The use of personal communication devices has increased astronomically over the last two decades. The penetration of mobile devices (also referred to as stations (STAs)) in modern society has continued to drive demand for a wide variety of networked devices in a number of disparate environments. The use of networked STAs using a variety of communication protocols and in a variety of networks, including Neighborhood Awareness Networks (NANs), has increased in all areas of home and work life. The STAs may be provided one of a number of different types of service, including unicast (STA to STA communication) and multicast (one or more publishers to one or more subscribers). Multicast service, especially for NAN2 devices, may be complicated due to the defined periodic schedules for negotiation between the NAN2 devices. The details of multicast scheduling, however, have not yet been defined in the current IEEE 802.11 NAN specification.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a wireless network in accordance with some embodiments.

FIG. 2 illustrates components of a communication device in accordance with some embodiments.

FIG. 3 illustrates a block diagram of a communication device in accordance with some embodiments.

FIG. 4 illustrates another block diagram of a communication device in accordance with some embodiments.

FIGS. 5A and 5B illustrate different multicast groups in accordance with some embodiments.

FIG. 6 illustrates a method of multicast scheduling in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

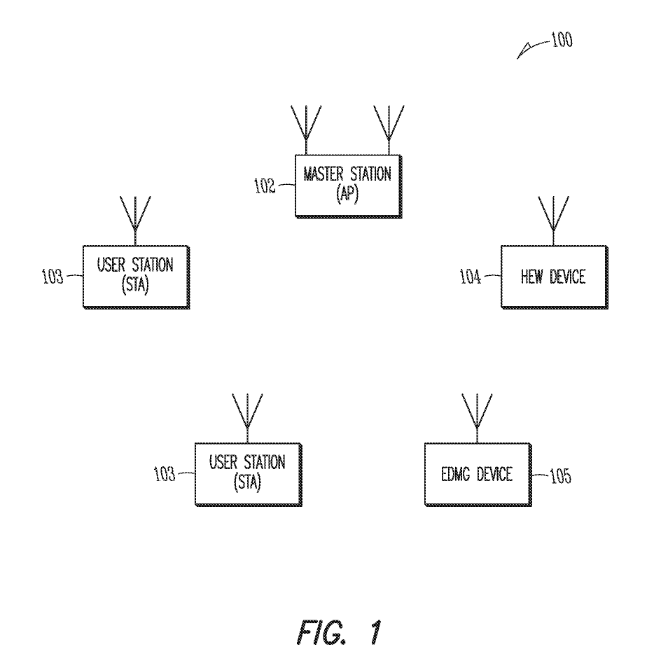

FIG. 1 illustrates a wireless network in accordance with some embodiments. In The network 100 may be a Wi-Fi Aware 2.0 Neighborhood Awareness Network (NAN), an Enhanced Directional Multi Gigabit (EDMG) network, a High Efficiency Wireless Local Area Network (HE) network, a Wireless Local Area Network (WLAN) or a Wi-Fi network. As an example, the network 100 may support EDMG devices in some cases, non EDMG devices in some cases, and a combination of EDMG devices and non EDMG devices in some cases. As another example, the network 100 may support HE devices in some cases, non-HE devices in some cases, and a combination of HE devices and non-HE devices in some cases. As another example, some devices supported by the network 100 may be configured to operate according to EDMG operation and/or HE operation and/or legacy operation. Accordingly, it is understood that although techniques described herein may refer to a non EDMG device, an EDMG device, a non HE device or an HE device, such techniques may be applicable to any or all such devices in some cases.

The network 100 may include any number (including zero) of master stations (STA) 102, user stations (STAs) 103, HE stations 104 (HE devices), and EDMG stations 105 (EDMG devices). Any of the STAs shown in FIG. 1 may act as a publisher and/or subscriber. The master station 102 may be a stationary non-mobile device, such as an access point (AP). In some embodiments, the STAs 103 may be legacy stations. These embodiments are not limiting, however, as the STAs 103 may be HE devices or may support HE operation in some embodiments. In some embodiments, the STAs 103 may be EDMG devices or may support EDMG operation. It should be noted that embodiments are not limited to the number of master STAs 102, STAs 103, HE stations 104 or EDMG stations 105 shown in the example network 100 in FIG. 1. The master station 102 may be arranged to communicate with the STAs 103 and/or the HE stations 104 and/or the EDMG stations 105 in accordance with one or more of the IEEE 802.11 standards. In accordance with some HE embodiments, an AP may operate as the master station 102 and may be arranged to contend for a wireless medium (e.g., during a contention period) to receive exclusive control of the medium for an HE control period (i.e., a transmission opportunity (TXOP)). The master station 102 may, for example, transmit a master-sync or control transmission at the beginning of the HE control period to indicate, among other things, which HE stations 104 are scheduled for communication during the HE control period. During the HE control period, the scheduled HE stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HE control period, the master station 102 may communicate with HE stations 104 using one or more HE frames. During the HE control period, STAs 103 not operating as HE devices may refrain from communicating in some cases. In some embodiments, the master-sync transmission may be referred to as a control and schedule transmission.

In some embodiments, a first STA 103 may transmit a grant frame to a second STA 103 to indicate a transmission of a data payload on primary channel resources or on secondary channel resources. The first STA 103 may receive an acknowledgement message for the grant frame from the second STA 103. The first STA 103 may transmit a data payload to the second STA 103 in the channel resources indicated in the grant frame. These embodiments will be described in more detail below.

In some embodiments, the multiple-access technique used during the HE control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HE control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HE stations 104 outside the HE control period in accordance with legacy IEEE 802.11 communication techniques, although this is not a requirement. The master station 102 may form a Basic Service Set (BSS) with the other STAs 103, 104, 105 having a BSSID and communicating using IEEE 802.11 protocols (using an IEEE 802.11a/b/g/n/ac or ax protocol) in a Wireless Local Area Network (WLAN) or Wi-Fi network.

In some embodiments, the HE communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel of an HE communication may be configured for transmitting a number of spatial streams.

In some embodiments, EDMG communication may be configurable to use channel resources that may include one or more frequency bands of 2.16 GHz, 4.32 GHz or other bandwidth. Such channel resources may or may not be contiguous in frequency. As a non-limiting example, EDMG communication may be performed in channel resources at or near a carrier frequency of 60 GHz.

In some embodiments, primary channel resources may include one or more such bandwidths, which may or may not be contiguous in frequency. As a non-limiting example, channel resources spanning a 2.16 GHz or 4.32 GHz bandwidth may be designated as the primary channel resources. As another non-limiting example, channel resources spanning a 20 MHz bandwidth may be designated as the primary channel resources. In some embodiments, secondary channel resources may also be used, which may or may not be contiguous in frequency. As a non-limiting example, the secondary channel resources may include one or more frequency bands of 2.16 GHz bandwidth, 4.32 GHz bandwidth or other bandwidth. As another non-limiting example, the secondary channel resources may include one or more frequency bands of 20 MHz bandwidth or other bandwidth.

In some embodiments, the primary channel resources may be used for transmission of control messages, beacon frames or other frames or signals by the AP 102. As such, the primary channel resources may be at least partly reserved for such transmissions. In some cases, the primary channel resources may also be used for transmission of data payloads and/or other signals. In some embodiments, the transmission of the beacon frames may be restricted such that the AP 102 does not transmit beacons on the secondary channel resources. Accordingly, beacon transmission may be reserved for the primary channel resources and may be restricted and/or prohibited in the secondary channel resources, in some cases.

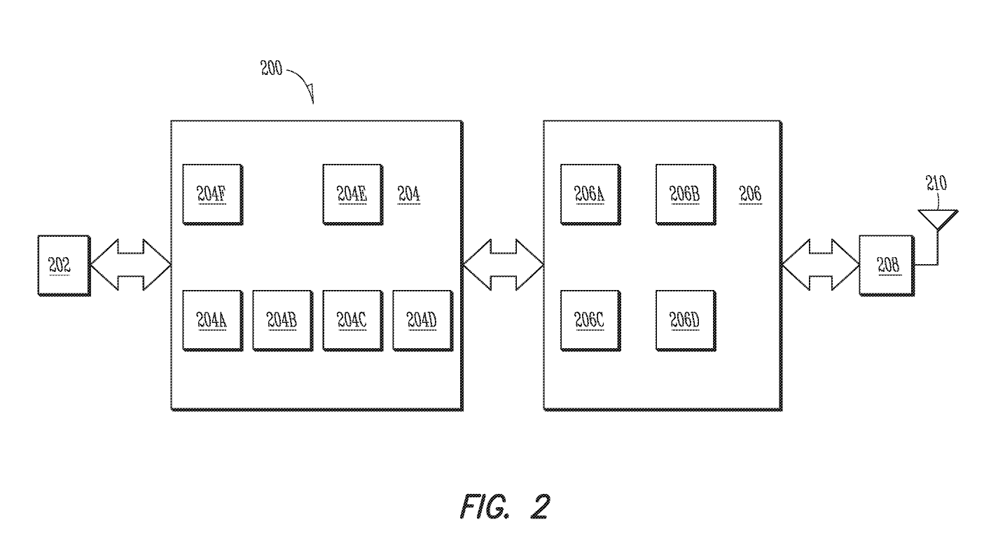

Embodiments described herein may be implemented into a system using any suitably configured hardware and/or software. FIG. 2 illustrates components of a STA in accordance with some embodiments. At least some of the components shown may be used in an AP, for example, such as the STA 102 or AP 104 shown in FIG. 1. The application or processing circuitry 202 may include one or more application processors. For example, the application circuitry 202 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 204 may include circuitry such as, but not limited to, one or more single-core or multi-core processors. The baseband circuitry 204 may include one or more baseband processors and/or control logic to process baseband signals received from a receive signal path of the RF circuitry 206 and to generate baseband signals for a transmit signal path of the RF circuitry 206. Baseband processing circuitry 204 may interface with the application circuitry 202 for generation and processing of the baseband signals and for controlling operations of the RF circuitry 206. For example, in some embodiments, the baseband circuitry 204 may include a second generation (2G) baseband processor 204a, third generation (3G) baseband processor 204b, fourth generation (4G) baseband processor 204c, and/or other baseband processor(s) 204d for other existing generations, generations in development or to be developed in the future (e.g., fifth generation (5G), 6G, etc.). The baseband circuitry 204 (e.g., one or more of baseband processors 204a-d) may handle various radio control functions that enable communication with one or more radio networks via the RF circuitry 206. The radio control functions may include, but are not limited to, signal modulation/demodulation, encoding/decoding, radio frequency shifting, etc. In some embodiments, modulation/demodulation circuitry of the baseband circuitry 204 may include Fast-Fourier Transform (FFT), precoding, and/or constellation mapping/demapping functionality. In some embodiments, encoding/decoding circuitry of the baseband circuitry 204 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 204 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 204e of the baseband circuitry 204 may be configured to run elements of the protocol stack for signaling of the PHY, MAC, RLC, PDCP and/or RRC layers. In some embodiments, the baseband circuitry may include one or more audio digital signal processor(s) (DSP) 204f. The audio DSP(s) 204f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 204 and the application circuitry 202 may be implemented together such as, for example, on a system on a chip (SOC).

In some embodiments, the baseband circuitry 204 may provide for communication compatible with one or more radio technologies. For example, in some embodiments, the baseband circuitry 204 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 204 is configured to support radio communications of more than one wireless protocol may be referred to as multi-mode baseband circuitry. In some embodiments, the STA 200 can be configured to operate in accordance with communication standards or other protocols or standards, including Institute of Electrical and Electronic Engineers (IEEE) 802.16 wireless technology (WiMax), IEEE 802.11 wireless technology (WiFi) including 802.1 lax, various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 2G, 3G, 4G, 5G, etc. technologies either already developed or to be developed.

RF circuitry 206 may enable communication with wireless networks using modulated electromagnetic radiation through a non-solid medium. In various embodiments, the RF circuitry 206 may include switches, filters, amplifiers, etc. to facilitate the communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some embodiments, the RF circuitry 206 may include a receive signal path and a transmit signal path. The receive signal path of the RF circuitry 206 may include mixer circuitry 206a, amplifier circuitry 206b and filter circuitry 206c. The transmit signal path of the RF circuitry 206 may include filter circuitry 206c and mixer circuitry 206a. RF circuitry 206 may also include synthesizer circuitry 206d for synthesizing a frequency for use by the mixer circuitry 206a of the receive signal path and the transmit signal path. In some embodiments, the mixer circuitry 206a of the receive signal path may be configured to down-convert RF signals received from the FEM circuitry 208 based on the synthesized frequency provided by synthesizer circuitry 206d. The amplifier circuitry 206b may be configured to amplify the down-converted signals and the filter circuitry 206c may be a low-pass filter (LPF) or band-pass filter (BPF) configured to remove unwanted signals from the down-converted signals to generate output baseband signals. Output baseband signals may be provided to the baseband circuitry 204 for further processing. In some embodiments, the output baseband signals may be zero-frequency baseband signals, although this is not a requirement. In some embodiments, mixer circuitry 206a of the receive signal path may comprise passive mixers, although the scope of the embodiments is not limited in this respect.

In some embodiments, the mixer circuitry 206a of the transmit signal path may be configured to up-convert input baseband signals based on the synthesized frequency provided by the synthesizer circuitry 206d to generate RF output signals for the FEM circuitry 208. The baseband signals may be provided by the baseband circuitry 204 and may be filtered by filter circuitry 206c. The filter circuitry 206c may include a low-pass filter (LPF), although the scope of the embodiments is not limited in this respect.

In some embodiments, the mixer circuitry 206a of the receive signal path and the mixer circuitry 206a of the transmit signal path may include two or more mixers and may be arranged for quadrature downconversion and/or upconversion respectively. In some embodiments, the mixer circuitry 206a of the receive signal path and the mixer circuitry 206a of the transmit signal path may include two or more mixers and may be arranged for image rejection (e.g., Hartley image rejection). In some embodiments, the mixer circuitry 206a of the receive signal path and the mixer circuitry 206a may be arranged for direct downconversion and/or direct upconversion, respectively. In some embodiments, the mixer circuitry 206a of the receive signal path and the mixer circuitry 206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206.

In some dual-mode embodiments, a separate radio IC circuitry may be provided for processing signals for each spectrum, although the scope of the embodiments is not limited in this respect. In some embodiments, the synthesizer circuitry 206d may be a fractional-N synthesizer or a fractional N/N+1 synthesizer, although the scope of the embodiments is not limited in this respect as other types of frequency synthesizers may be suitable. For example, synthesizer circuitry 206d may be a delta-sigma synthesizer, a frequency multiplier, or a synthesizer comprising a phase-locked loop with a frequency divider.

The synthesizer circuitry 206d may be configured to synthesize an output frequency for use by the mixer circuitry 206a of the RF circuitry 206 based on a frequency input and a divider control input. In some embodiments, the synthesizer circuitry 206d may be a fractional N/N+1 synthesizer.

In some embodiments, frequency input may be provided by a voltage controlled oscillator (VCO), although that is not a requirement. Divider control input may be provided by either the baseband circuitry 204 or the applications processor 202 depending on the desired output frequency. In some embodiments, a divider control input (e.g., N) may be determined from a look-up table based on a channel indicated by the applications processor 202.

Synthesizer circuitry 206d of the RF circuitry 206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 206 may include an IQ/polar converter.

FEM circuitry 208 may include a receive signal path which may include circuitry configured to operate on RF signals received from one or more antennas 210, amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210.

In some embodiments, the FEM circuitry 208 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210.

In some embodiments, the STA 200 may include additional elements such as, for example, memory/storage, display, camera, sensor, and/or input/output (I/O) interface as described in more detail below. In some embodiments, the STA 200 described herein may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the STA 200 may include one or more user interfaces designed to enable user interaction with the system and/or peripheral component interfaces designed to enable peripheral component interaction with the system. For example, the STA 200 may include one or more of a keyboard, a keypad, a touchpad, a display, a sensor, a non-volatile memory port, a universal serial bus (USB) port, an audio jack, a power supply interface, one or more antennas, a graphics processor, an application processor, a speaker, a microphone, and other I/O components. The display may be an LCD or LED screen including a touch screen. The sensor may include a gyro sensor, an accelerometer, a proximity sensor, an ambient light sensor, and a positioning unit. The positioning unit may communicate with components of a positioning network, e.g., a global positioning system (GPS) satellite.

The antenna 210 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 210 may be effectively separated to take advantage of spatial diversity and the different channel characteristics that may result.

Although the STA 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

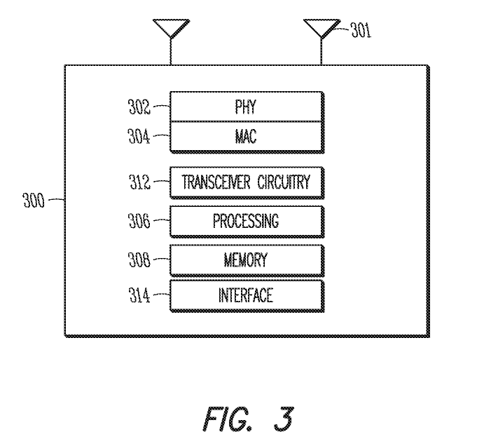

FIG. 3 is a block diagram of a communication device in accordance with some embodiments. The device may be a STA or AP, for example, such as the STA 102 or AP 104 shown in FIG. 1. The communication device 300 may include physical layer circuitry 302 and transceiver circuitry 312 for transmitting and receiving signals to and from one or more APs, STAs or other devices using one or more antennas 301. The communication device 300 may also include medium access control layer (MAC) circuitry 304 for controlling access to the wireless medium. The communication device 300 may also include processing circuitry 306, such as one or more single-core or multi-core processors, and memory 308 arranged to perform the operations described herein. The communication device 300 may also include wired and/or wireless interfaces 310 to communicate with components external to the network. The physical layer circuitry 302, MAC circuitry 304 and processing circuitry 306 may handle various radio control functions that enable communication with one or more radio networks compatible with one or more radio technologies. The radio control functions may include signal modulation, encoding, decoding, radio frequency shifting, etc. For example, similar to the device shown in FIG. 2, in some embodiments, communication may be enabled with one or more of a WMAN, a WLAN, and a WPAN. In some embodiments, the communication device 300 can be configured to operate in accordance with 3GPP standards or other protocols or standards, including WiMax, WiFi, GSM, EDGE, GERAN, UMTS, UTRAN, or other 3G, 3G, 4G, 5G, etc. technologies either already developed or to be developed. The physical layer circuitry 202, MAC layer circuitry 304, transceiver circuitry 312, processing circuitry 308, memory 308 and interfaces 310 may be separate components or may be part of a combined component.

The antennas 301 may comprise one or more directional or omnidirectional antennas, including, for example, dipole antennas, monopole antennas, patch antennas, loop antennas, microstrip antennas or other types of antennas suitable for transmission of RF signals. In some MIMO embodiments, the antennas 301 may be effectively separated to take advantage of spatial diversity and the different channel characteristics that may result.

Although the communication device 300 is illustrated as having several separate functional elements, one or more of the functional elements may be combined and may be implemented by combinations of software-configured elements, such as processing elements including DSPs, and/or other hardware elements. For example, some elements may comprise one or more microprocessors, DSPs, FPGAs, ASICs, RFICs and combinations of various hardware and logic circuitry for performing at least the functions described herein. In some embodiments, the functional elements may refer to one or more processes operating on one or more processing elements. Embodiments may be implemented in one or a combination of hardware, firmware and software. Embodiments may also be implemented as instructions stored on a computer-readable storage device, which may be read and executed by at least one processor to perform the operations described herein.

In some embodiments, the communication device 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly.

In some embodiments, the communication device 300 may communicate using OFDM communication signals over a multicarrier communication channel. Accordingly, in some cases the communication device 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HE standards, although the scope of the invention is not limited in this respect as they may also be suitable to transmit and/or receive communications in accordance with other techniques and standards. In some other embodiments, the communication device 300 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In accordance with embodiments, the communication device 300 may transmit an SM-OFDM signal that comprises multiple OFDM signals, and the SM-OFDM signal may be received at the communication device 300. The SM-OFDM signal may be transmitted in channel resources that comprise multiple sub-carriers and the OFDM signals may be based at least partly on data symbols for used data portions of the sub-carriers. The used data portions may be based on a first portion of encoded bits and the data symbols for the used data portions may be based on a second portion of the encoded bits. In some examples, the used data portions of the sub-carriers may be different for at least some of the OFDM signals.

In some embodiments, the channel resources may be used for downlink transmission and for uplink transmissions by the communication device 300. That is, a time-division duplex (TDD) format may be used. In some cases, the channel resources may include multiple channels, such as the 20 MHz channels previously described. The channels may include multiple sub-channels or may be divided into multiple sub-channels for the uplink transmissions to accommodate multiple access for multiple communication devices 300. The downlink transmissions may or may not utilize the same format.

In some embodiments, the downlink sub-channels may comprise a predetermined bandwidth. As a non-limiting example, the sub-channels may each span 2.03125 MHz, the channel may span 20 MHz, and the channel may include eight or nine sub-channels. Although reference may be made to a sub-channel of 2.03125 MHz for illustrative purposes, embodiments are not limited to this example value, and any suitable frequency span for the sub-channels may be used. In some embodiments, the frequency span for the sub-channel may be based on a value included in an 802.11 standard (such as 802.11ax), a 3GPP standard or other standard.

In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

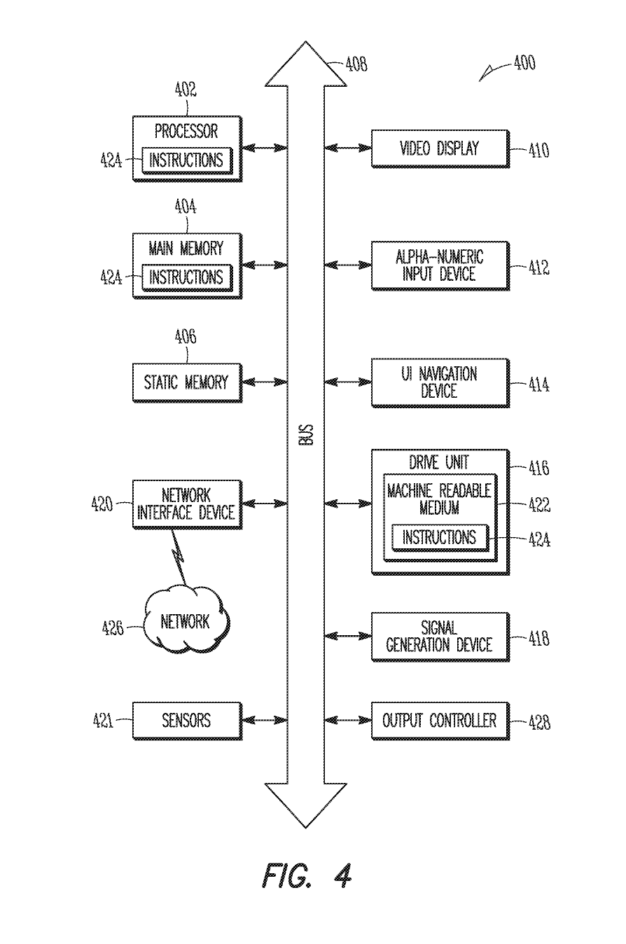

FIG. 4 illustrates another block diagram of a communication device in accordance with some embodiments. In alternative embodiments, the communication device 400 may operate as a standalone device or may be connected (e.g., networked) to other communication devices. In a networked deployment, the communication device 400 may operate in the capacity of a server communication device, a client communication device, or both in server-client network environments. In an example, the communication device 400 may act as a peer communication device in peer-to-peer (P2P) (or other distributed) network environment. The communication device 400 may be an AP or a STA such as a PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The communication device 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The communication device 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The communication device 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a communication device readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the communication device 400. In an example, one or any combination of the hardware processor 402, the main memory 404, the static memory 406, or the storage device 416 may constitute communication device readable media.

While the communication device readable medium 422 is illustrated as a single medium, the term “communication device readable medium” may include a single medium or multiple media (e.g., a centralized or distributed database, and/or associated caches and servers) configured to store the one or more instructions 424.

The term “communication device readable medium” may include any medium that is capable of storing, encoding, or carrying instructions for execution by the communication device 400 and that cause the communication device 400 to perform any one or more of the techniques of the present disclosure, or that is capable of storing, encoding or carrying data structures used by or associated with such instructions. Non-limiting communication device readable medium examples may include solid-state memories, and optical and magnetic media. Specific examples of communication device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device readable media may include non-transitory communication device readable media. In some examples, communication device readable media may include communication device readable media that is not a transitory propagating signal.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), MIMO, or multiple-input single-output (MISO) techniques. In some examples, the network interface device 420 may wirelessly communicate using Multiple User MIMO techniques. The term “transmission medium” shall be taken to include any intangible medium that is capable of storing, encoding or carrying instructions for execution by the communication device 400, and includes digital or analog communications signals or other intangible medium to facilitate communication of such software.

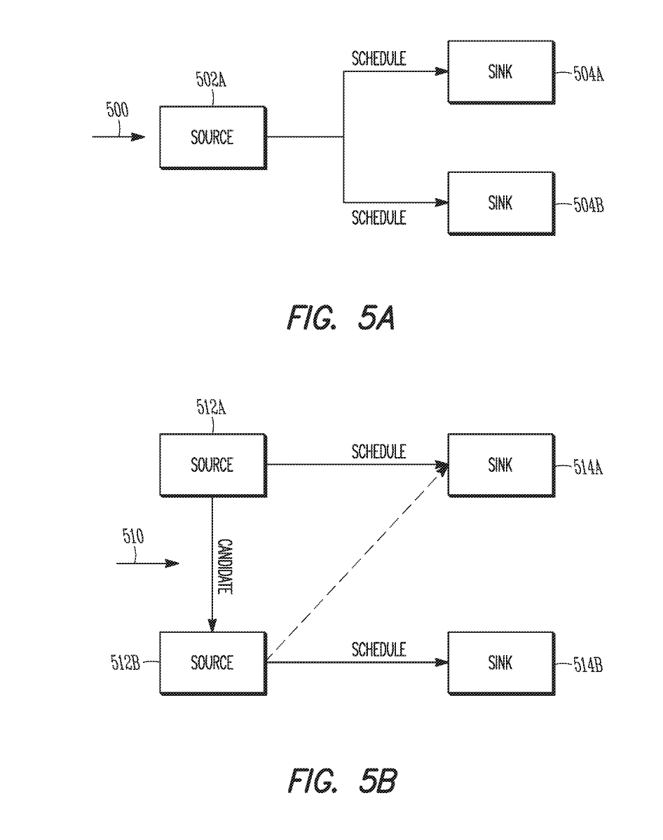

As above, a NAN2 multicast group may be created to handle multicast service. Specifically, a multicast service may have a corresponding multicast group. FIGS. 5A and 5B illustrate different multicast groups in accordance with some embodiments. A multicast group 500 can be a one-to-many multicast group 500 having one publisher 502 providing the same service to multiple subscribers 504a, 504b, as shown in FIG. 5A, or a many-to-many multicast group 510 having multiple publishers 512a, 512b providing the same service to multiple subscribers 514a, 514b, as shown in FIG. 5B. Each publisher may be a STA an AP or STA such as a personal device. A one-to-many multicast group 500 may, for example, deliver news, while a many-to-many multicast group 510 may, for example, be used for multicast gaming. In some embodiments, the many-to-many multicast group 510 shown in FIG. 5B may include multicast publishers 512a, 512b that each reach all or only some of the subscribers 514a, 514b. The number of subscribers 514a, 514b in the many-to-many multicast group 510 may in general be larger than the number of publishers 512a, 512b, as shown, but dependent on the number of subscribers 514a, 514b that have registered for a particular service may be fewer than the number of publishers 512a, 512b at times. However, while multicast groups are discussed in the current 802.11 NAN2 specification, no such specifications have been provided regarding the scheduling of multicast transmissions for these different multicast groups 500, 510. Accordingly, differentiation between the scheduling of a one-to-many multicast group 500 and a many-to-many multicast group 510 is presented herein.

In some embodiments, the one-to-many multicast group 500 may be initiated and subsequently maintained/controlled by the multicast publisher 502. As a single multicast schedule may be generated and controlled by a single entity, the multicast publisher 502, negotiation between the multicast publisher 502 and the multicast subscribers 504a, 504b for the multicast schedule may be avoided. The multicast schedule may be a collection of time slots for transmission of the service, which may be, as indicated further below, be selected from the time slots of a multicast schedule candidate. The multicast schedule and multicast schedule candidate may have the same time slots, or the multicast schedule may be a subset of the time slots of the multicast schedule candidate. The multicast schedule may be used by the multicast subscribers 504a, 504b to receive data from the multicast publisher 502 for the associated multicast service. In some embodiments, the multicast publisher 502 may initiate multiple one-to-many multicast groups, in which each multicast group may have an independent multicast schedule and an independent set of multicast subscribers. In embodiments in which the multicast publisher 502 initiates multiple one-to-many multicast groups, the multicast publisher may control each of the multicast schedules, thereby reducing the complexity of multiple schedules being maintained. This, in some respects, may be similar to a Network Digital Link schedule for multiple Neighbor Discovery Protocols (NDPs).

The multicast publisher may update the multicast schedule for each of the one-to-many multicast groups by broadcasting a multicast schedule attribute in a service discovery frame (SDF) or public action frame for a schedule update. The update may not be negotiated between the multicast publisher and a multicast subscriber or other multicast publisher. The multicast schedule may be used by the multicast subscribers to receive data from the multicast publisher for the associated multicast service. In some embodiments, the multicast service may be able to be provided as both a multicast service and a unicast service. In such embodiments, the multicast schedule attribute may contain a unicast/multicast (U/M) bit for the associated one-to-many multicast group to indicate whether the multicast schedule can also be used for a unicast transmission. In this case, a unicast schedule setup procedure may be bypassed, thereby further reducing the complexity. The multicast publisher may be permitted to send unicast traffic (i.e., a unicast transmission) to the multicast subscriber to provide the same service as the multicast transmission. Similarly, the multicast subscriber may similarly be permitted to send unicast traffic to the multicast publisher for the same service. The multicast publisher may simultaneously transmit multicast traffic to other multicast subscribers. While the multicast subscriber may be able to obtain a multicast service by joining a multicast group, the multicast subscriber may instead (or in addition) establish a unicast NDL with the multicast publisher in response to the multicast subscriber determining that the U/M bit indicates that the multicast transmission can also be used for a unicast transmission. In this case, the unicast NDL may be separate from the multicast service. The U/M bit may be included in one or both a multicast schedule attribute and a multicast group attribute of the multicast schedule frame used to schedule the multicast service.

In some embodiments, the many-to-many multicast group 510 may be initiated by one of the multicast publishers 512a and other multicast publishers 512b and multicast subscribers 514a, 514b may thereafter join the multicast group. In some embodiments, the multicast publishers 512a, 512b may negotiate amongst themselves which multicast publisher is to control the multicast group after initiation, perhaps including scheduling. While the initiator and controller are usually the same, they may differ in some embodiments. For example, instead of control of the many-to-many multicast group 510 being retained by the initiating multicast publisher, the control may rotate among the multicast publishers 512a, 512b on a temporal basis, on the basis of an amount of data transmitted by a particular multicast publisher 512a, 512b or dependent on conditions of the various multicast publishers 512a, 512b. In some embodiments, the control may change between multicast publishers 512a, 512b once a particular multicast publisher 512a, 512b has provided control for a predetermined period or a predetermined amount of data (e.g., number of packets). In some embodiments, the control may change between multicast publishers 512a, 512b in response to one or more conditions, for example, network conditions such as channel quality or device conditions, such as buffer size, remaining battery power falling below a predetermined threshold or battery power falling below a relative threshold compared to at least one other of the multicast publishers 512a, 512b, power publisher (battery/wall) or power publisher compared to at least one other of the multicast publishers 512a, 512b.

In embodiments in which a particular multicast publisher initiates multiple many-to-many multicast groups, the particular multicast publisher may in some embodiments control each of the multicast schedules, thereby reducing the complexity of maintaining multiple schedules. In this case, as shown in FIG. 5B, the multicast schedule may be supplied only by the initiating multicast publisher 512a. In other embodiments, the multicast schedule may also be supplied by other multicast publishers 512b with the final multicast schedule received by the multicast subscriber being used, or, if differences exist between the multicast schedules, the multicast subscriber requesting confirmation of the last multicast schedule from the multicast publisher transmitting the schedule. In other embodiments however, control of the multiple many-to-many multicast groups may change such that, in each many-to-many multicast group in which the control is able to change, the control may shift among the multicast publishers of the many-to-many multicast group. The control in one or more (e.g., each) of these many-to-many multicast groups may change based on the same conditions or combination of conditions, or the conditions under which control changes for one or more of these many-to-many multicast groups may be independent of others of the many-to-many multicast groups. Thus, although a particular multicast publisher may belong to multiple multicast groups, control may shift independently for each multicast group so that the particular multicast publisher may at various points control from none of the multicast groups to all of the multicast groups. In some embodiments, control of only some the multiple many-to-many multicast groups to which the particular multicast publisher belongs may change, while others may remain with the initiating multicast publisher.

A particular multicast publisher that belongs to multiple many-to-many multicast groups, as an initiator/controller or a member, may broadcast and maintain (whether or not the particular multicast publisher controls) a multicast schedule for each of the many-to-many multicast groups. The multicast schedule of a particular many-to-many multicast group may be dependent on the availabilities of the multicast publishers in the many-to-many multicast group. Thus, if the multicast schedule is negotiated among the multicast publishers, the multicast schedules of different many-to-many multicast groups may be different due to the presence of multiple multicast publishers (which may differ from group to group) involved in the schedule decision. In some embodiments, the different multicast publishers may coordinate to have similar multicast schedules so that a multicast subscriber that is a member of the different multicast groups (to which the particular multicast publisher belongs) is able to wake up for fewer time slots to receive multicast service from the different multicast publishers in the same multicast group. However, whether the multicast service is unilaterally scheduled by a single multicast publisher or whether schedule coordination between multiple multicast publishers is present, the multicast scheduling may in some embodiments be publisher-dependent, rather than subscriber-dependent, i.e., while one or more of the multicast publishers may negotiate to determine the multicast schedule, the multicast publishers may avoid negotiation with the multicast subscribers to determine the multicast schedule.

The multicast publisher may update the multicast schedule for each of the many-to-many multicast groups maintained by the multicast publisher by broadcasting a multicast schedule attribute in a SDF or public action frame for a schedule update. In some embodiments, the multicast schedule attribute may contain a U/M bit for the associated many-to-many multicast group to indicate whether the multicast schedule can also be used for a unicast transmission.

The multicast publishers in the same multicast group may have multicast schedules that fully or partially overlap, or may have no overlap. For the multicast publishers in the same multicast group, a relationship may exist between the multicast schedules maintained by the multicast publishers for the multicast group. In some embodiments, the initiating multicast publisher that starts the multicast group may determine a collection of time slots, referred to as a multicast schedule candidate. The initiating multicast publisher may select the multicast schedule from a subset of the time slot collections of the multicast schedule candidate. In some embodiments, each of the multicast publishers that joins the multicast group may choose the multicast schedule from the multicast schedule candidate. The multicast schedule selected by the particular multicast publisher from the multicast schedule candidate may be transmitted to the controller multicast publisher. In some embodiments, the multicast schedule selected by the particular multicast publisher may be constrained by the controller multicast publisher dependent on geographical or subscriber overlap such that for increasing overlap between the multicast publisher, selections may be limited from the multicast schedule candidate. In various embodiments, the multicast schedule for a particular subscriber or publisher may be decided by the initiator of the multicast group or may be advertised by the multicast publisher that enrolls the subscriber/publisher with the multicast group.

The multicast schedule candidate may be included in multicast group attribute/multicast schedule attribute and the multicast group attribute/multicast schedule attribute may be in the SDF for a many-to-many multicast group. The multicast schedule candidate in some embodiments may not be included in the multicast group set for a one-to-many multicast group. A candidate bit that indicates whether a multicast schedule candidate may be provided in the multicast group attribute or multicast schedule attribute. Every multicast publisher in the multicast group may select among the time slots of the same multicast schedule candidate and may select, for example, the same time slots as the multicast schedule candidate. This can be achieved in embodiments in which every multicast publisher reuses the multicast schedule determined by the initiating multicast publisher. A pair or more of bits in the multicast schedule attribute or multicast group attribute may be used to indicate multicast schedule selection policy such as: to follow the same multicast schedule acquired when joining the multicast group, to use the multicast schedule candidate as the multicast schedule, and/or to be free to choose multicast schedule individually. The multicast schedule selection policy may be set by default to follow the same multicast schedule acquired when joining the multicast group. Other bits in the multicast schedule attribute or multicast group attribute may in some embodiments specify particular time slots or an amount of the multicast schedule of the initiator or enrolling publisher to use.

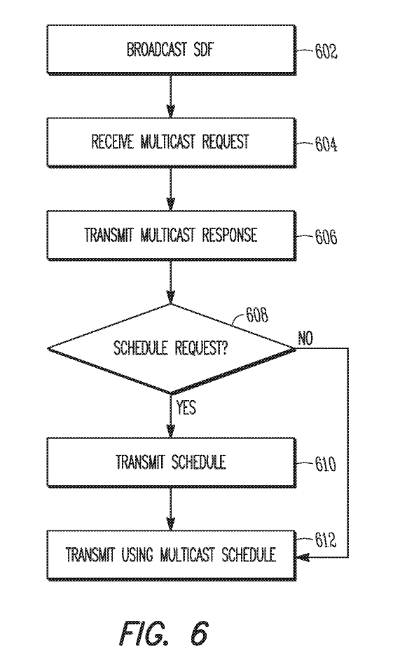

FIG. 6 illustrates a method of multicast scheduling in accordance with some embodiments. Any of the STAs shown in FIGS. 1-4 may perform the method shown in FIG. 6. FIG. 6 may be used for joining a one-to-many or many-to-many multicast group. In some embodiments, any of the multicast publishers in the multicast group may be able to enroll another STA with the multicast group through a message exchange. At operation 602, a multicast publisher in a multicast group may broadcast its existence through an SDF. The SDF may include a multicast group attribute and multicast schedule attribute. The SDF may be broadcast at predetermined times that are known by STAs. In different embodiments, if multiple multicast publishers are present for the multicast group, the SDFs from some or all of the multicast publishers may be broadcast independently or may be broadcast at the same time.

A STA may receive the SDF from a multicast publisher. After decoding the broadcast, the STA may wish to become a multicast subscriber for a particular group. In this case, the STA can send a multicast request to the multicast publisher, where it is received at operation 604. Each of the subscriber and publisher may be, for example, a NAN2 device and may establish NAN2 data path (NDP) to support data communication between the NAN devices for that service. The NAN2 data path for the service may be established by setting up a NAN2 Data Link (NDL).

In response to receiving the request from the STA, the multicast publisher may transmit to the STA, at operation 606, a multicast response such as a Service Discovery Frame. The multicast response may contain an enrollment rule to permit the STA to complete the group joining process for the desired group. In some embodiments, the multicast subscriber may, via the enrollment rule, be prohibited from enrolling other STAs (as subscribers) with the multicast group, which ensures that each multicast publisher is connected to at least one another multicast publisher and the multicast schedule relation can be maintained.

The multicast response may, in some embodiments, contain information about the multicast schedule for the multicast group. In other embodiments, for either or both one-to-many or many-to-many multicast services, a multicast subscriber can request the multicast publisher to send out the latest multicast schedule. In this case, the multicast publisher may receive, at operation 608, a public action frame or management frame from the multicast subscriber.

The choice of which multicast publisher to request to transmit the latest multicast schedule for a many-to-many multicast service may depend on the multicast schedule provided by the different multicast publishers and which multicast publisher is providing the multicast service to the multicast subscriber. In some embodiments, the same multicast publisher servicing the multicast subscriber may transmit the schedule; in other embodiments, the request may be provided to a different, perhaps dedicated, multicast publisher that is able to reach the multicast subscriber. The multicast publisher, having received the request at operation 608, can may subsequently at operation 610 transmit or have transmitted a response such as management frame or public action frame with the multicast schedule attribute to the multicast subscriber. The response may be provided through a broadcast message or a unicast message to the multicast subscriber.

Whether or not the schedule is requested and transmitted, eventually, the multicast service may be transmitted at operation 612. In some embodiments, the multicast schedule candidate may be set as the multicast schedule of the initiating multicast publisher that started the multicast group. In this case, all multicast publishers may transmit using a multicast schedule that is a subset (or all) of the multicast schedule candidate of the initiating multicast publisher. In some embodiments, the multicast schedule candidate can be the same as the multicast schedule of the initiating multicast publisher. An algorithm can be designed to ensure that different multicasts use the same multicast schedule. A schedule bit in the multicast schedule attribute or multicast group attribute may be used in one embodiment to enforce the multicast schedule. For example, multicast group schedule attribute broadcasted by the initiating multicast publisher may be devoid of a multicast schedule candidate. In this case, multicast publishers that join the multicast group through the initiating multicast publisher may follow the multicast schedule broadcasted by the candidate multicast publisher. The specific decision of which subset of the multicast schedule candidate to use may depend on the implementation.

Alternatively, the multicast schedule candidate may include more time slots than the multicast schedule of the initiating multicast publisher. In this case, each multicast publisher may maintain a unique set of time slots to accommodate different availability requirements and avoid collision. An algorithm can also be used to ensure that the different multicast schedules choose non-overlapping time slots. For example, a schedule bit in the multicast schedule attribute or multicast group attribute may be used to enforce selection of the non-overlapping time slots. The specific decision of which subset of multicast schedule candidate to use may depend on the implementation.

An example of a multicast group attribute is shown in Table 1. An example of a multicast schedule attribute is shown in Table 2.

TABLE 1
Multicast Group Attribute

| | Size | | |
|---|---|---|---|
| Field | (octets) | Value | Description |
| Attribute ID | 1 | TBD | Identifies the type of NAN attribute. |
| Length | 2 | Variable | Length of the following fields in the attribute. |
| Service ID | 6 | Variable | Service for which the NDP is requested for |
| Instance ID | 1 | Variable | Instance ID of the service (received in publish message) |
| Data Interface | 6 | Variable | MAC Address of the Data Interface |
| Address | | | |
| NMSG-ID | 1 | Variable | Token |
| Multicast | 6 | Variable | Multicast Address for one to many traffic |
| Address | | | |
| Multicast | 1 | Variable | One bit to Indicate if unicast is allowed |
| Control | | | One bit to indicate if security is included |
| | | | One bit to indicate if multicast schedule candidate is |
| | | | present (exists if multicast schedule candidate is included |
| | | | in multicast group attribute) |
| | | | Several bits to indicate multicast schedule select policy |
| | | | for many-to-many |
| Security | TBD | Variable | Contains all information with respect to security (TBD) |
| Map ID | 1 | Variable | (present if multicast schedule is present in multicast |
| | | | group attribute) Indicate the NAN Availability attribute |
| | | | that specifies the channel information associated with the |
| | | | multicast schedule candidate available time blocks |
| Time Bitmap | 3 | Variable | (present if multicast schedule is present in multicast |
| Control | | | group attribute) A field that indicates the parameters |
| | | | associated with the following Time Bitmap field. See |
| | | | Table 5.11 for details. |
| Time Bitmap | 1 | Variable | (present if multicast schedule is present in multicast |
| | | | group attribute) Indicate the multicast schedule candidate |
| | | | time blocks |

TABLE 2
Multicast Schedule Attribute

| | Size | | |
|---|---|---|---|
| Field | (octets) | Value | Description |
| Attribute ID | 1 | TBD | Identifies the type of NAN attribute. |
| Length | 2 | Variable | Length of the following fields in the attribute. |
| Data | 6 | Variable | The NAN Data Interface Address for this Multicast |
| Interface | | | Schedule |
| Address | | | |
| Map ID | 1 | Variable | Indicate the NAN Availability attribute that specifies |
| | | | the channel information associated with the multicast |
| | | | schedule time blocks |
| Time Bitmap | 3 | Variable | A field that indicates the parameters associated with |
| Control | | | the following Time Bitmap field. See Table 5.11 for |
| | | | details. |
| Time Bitmap | 1 | Variable | Indicate the multicast available time blocks |
| Map ID | 1 | Variable | (present if multicast schedule is present in multicast |
| | | | schedule attribute) Indicate the NAN Availability |
| | | | attribute that specifies the channel information |
| | | | associated with the multicast schedule candidate |
| | | | available time blocks |
| Time Bitmap | 3 | Variable | (present if multicast schedule is present in multicast |
| Control | | | schedule attribute) A field that indicates the |
| | | | parameters associated with the following Time Bitmap |
| | | | field. See Table 5.11 for details. |
| Time Bitmap | 1 | Variable | (present if multicast schedule is present in multicast |
| | | | schedule attribute) indicate the multicast schedule |
| | | | candidate time blocks |

In one example, a first STA initiates a many-to-many multicast group. The first STA is a multicast publisher and the multicast initiator. A second STA may join the multicast group through the first STA or a third STA, which may be another multicast publisher to be able to enroll another STA to the multicast group. The second STA may itself become a multicast publisher. The multicast initiator may select both a multicast schedule and a multicast schedule candidate. The multicast schedule candidate may be selected by the multicast initiator after choosing the multicast schedule and may be provided to the other STAs accordingly. The second STA may select the multicast schedule by following the multicast schedule of the STA that enrolled the second STA or may choose the multicast schedule from the multicast schedule candidate announced by the STA that enrolled the second STA. Note that for a one-to-many multicast group, only one multicast publisher exists. This multicast group is the initiator of the multicast group. In this case, no other STAs in the multicast group may be able to enroll other STA in the multicast group (i.e., the second STA may not be able to be a multicast publisher in the one-to-many multicast group).

### Examples

Example 1 is an apparatus of a wireless device configured to operate as a multicast publisher, the apparatus comprising: a memory; and processing circuitry arranged to: initiate a multicast group for a multicast service in a Neighborhood Awareness Network (NAN), the multicast group being a one-to-many or many-to-many multicast group; establish a multicast schedule and a multicast schedule candidate for the multicast service, time slots of the multicast schedule being at least a subset of time slots of the multicast schedule candidate; coordinate multicast schedules of other multicast publishers in the multicast group; decode a request from a multicast subscriber to join the multicast group; generate a Service Discovery Frame (SDF) in response to the request to the multicast subscriber, the SDF comprising a multicast schedule to provide data of the multicast service from the multicast publisher.

In Example 2, the subject matter of Example 1 optionally includes, wherein the processing circuitry is further arranged to: maintain the multicast group after initiation of the multicast group.

In Example 3, the subject matter of any one or more of Examples 1-2 optionally include, wherein the processing circuitry is further arranged to: initiate multiple multicast groups; and maintain a multicast schedule of each of the multicast groups.

In Example 4, the subject matter of any one or more of Examples 1-3 optionally include, wherein the processing circuitry is further arranged to: update the multicast schedule via transmission of one of a service discovery frame (SDF) or public action frame for a schedule update broadcast comprising a multicast schedule attribute.

In Example 5, the subject matter of any one or more of Examples 1-4 optionally include, wherein the processing circuitry is further arranged to: generate one of a multicast schedule attribute or a multicast group attribute of a multicast schedule frame, used to schedule the multicast service, that comprises a unicast/multicast (U/M) bit for the multicast group to indicate whether the multicast schedule is able to be used for a unicast transmission.

In Example 6, the subject matter of Example 5 optionally includes, wherein: the U/M bit indicates that the multicast schedule is able to be used for a unicast transmission, and the processing circuitry is further arranged to: decode a request for unicast service for the multicast service from a unicast subscriber, and in response to the request, bypass a unicast schedule setup procedure for the unicast subscriber.

In Example 7, the subject matter of Example 6 optionally includes, wherein the processing circuitry is further arranged to: generate multicast traffic for the multicast service directed to the multicast subscriber simultaneously with generation of unicast traffic for the unicast subscriber.

In Example 8, the subject matter of any one or more of Examples 1-7 optionally include, wherein the processing circuitry is further arranged to: initiate multiple many-to-many multicast groups; decode a request to join one of the many-to-many multicast groups from at least one multicast publisher; and control a multicast schedule of each of the many-to-many multicast groups.

In Example 9, the subject matter of Example 8 optionally includes, wherein the processing circuitry is further arranged to: determine multicast schedules for the many-to-many multicast groups, the multicast schedules of each of the many-to-many multicast groups dependent on multicast publishers that have joined the many-to-many multicast group and independent of the multicast schedule of multicast publishers of other many-to-many multicast groups.

In Example 10, the subject matter of any one or more of Examples 1-9 optionally include, wherein the processing circuitry is further arranged to: coordinate multicast schedules for a plurality of multicast publishers associated with the multicast group to permit a multicast subscriber that is a member of the multicast group to wake up for fewer time slots to receive the multicast service from the plurality of multicast publishers.

In Example 11, the subject matter of Example 10 optionally includes, wherein the processing circuitry is further arranged to: permit another multicast publisher that joins the multicast group to select a multicast schedule from the time slots of the multicast schedule candidate.

In Example 12, the subject matter of any one or more of Examples 1-11 optionally include, wherein the processing circuitry is further arranged to: generate one of a multicast group attribute or multicast schedule attribute that includes the multicast schedule candidate in the one of the multicast group attribute and multicast schedule attribute, wherein the one of a multicast schedule attribute or multicast group attribute comprises a multicast schedule selection policy selected from among at least: to follow the multicast schedule acquired when joining the multicast group, to determine a multicast schedule from the multicast schedule candidate, and to be free to choose a multicast schedule.

In Example 13, the subject matter of any one or more of Examples 1-12 optionally include, wherein the processing circuitry is further arranged to: indicate to a station that has requested to join the multicast group an enrollment rule that indicates which is to be followed of: the station is able to enroll another station with the multicast group through a message exchange or the station is prohibited from enrolling the other station with the multicast group.

In Example 14, the subject matter of any one or more of Examples 1-13 optionally include, wherein the processing circuitry is further arranged to: decode a request from the multicast subscriber for a latest multicast schedule, the request received in one of a public action frame or management frame, and in response to reception of the request, generate one of another management frame or public action frame with the latest multicast schedule attribute through one of a broadcast message or a unicast message to the multicast subscriber.

In Example 15, the subject matter of any one or more of Examples 1-14 optionally include, further comprising: an antenna configured to transmit to and receive transmissions from the multicast subscriber and other multicast publishers.

Example 16 is a method of providing multicast communications, the method comprising: determining a multicast schedule for a multicast service in a Neighborhood Awareness Network (NAN), the multicast schedule used to receive data from a multicast publisher for the multicast service, time slots of the multicast schedule comprising time slots of a multicast schedule candidate or a subset of the time slots of the multicast schedule candidate; receiving a request from a multicast subscriber to join a multicast group associated with a multicast service, the multicast group being one-to-many or many-to-many; transmitting a Service Discovery Frame (SDF) in response to the request to the multicast subscriber, the SDF comprising the multicast schedule.

In Example 17, the subject matter of Example 16 optionally includes, further comprising: generating one of a multicast schedule attribute or a multicast group attribute of a multicast schedule frame that comprises a unicast/multicast (U/M) bit for the multicast group to indicate whether the multicast schedule is able to be used for a unicast transmission; and scheduling the multicast service using the one of the multicast schedule attribute or the multicast group attribute.

In Example 18, the subject matter of Example 17 optionally includes, further comprising: receiving a request for unicast transmission when the U/M bit indicates that the multicast schedule is able to be used for a unicast transmission; and bypassing a unicast schedule setup procedure in response to receiving the request for the unicast transmission.

In Example 19, the subject matter of any one or more of Examples 16-18 optionally include, at least one of: the method further comprises at least one of: setting multicast schedules for many-to-many multicast groups, the multicast schedules of each of the many-to-many multicast groups dependent on multicast publishers that have joined the many-to-many multicast group and independent of the multicast schedule of other many-to-many multicast groups, or coordinating multicast schedules for a plurality of multicast publishers associated with the multicast group to permit a multicast subscriber that is a member of the multicast group to wake up for fewer time slots to receive the multicast service from the plurality of multicast publishers; or an initiating multicast publisher that initiates the multicast group determines the multicast schedule candidate, the multicast schedule candidate is included in one of a multicast group attribute and multicast schedule attribute provided by the initiating multicast publisher, and a multicast schedule of each multicast publisher that joins the multicast group is selected by the multicast publisher from the multicast schedule candidate dependent on a multicast schedule selection policy, the multicast schedule selection policy selected from among at least: to follow the multicast schedule acquired when joining the multicast group, to use the multicast schedule candidate to determine a multicast schedule, and to be free to choose a multicast schedule.

In Example 20, the subject matter of any one or more of Examples 16-19 optionally include, further comprising at least one of: transmitting to a station that has requested to join the multicast group an enrollment rule that indicates which is to be followed of: the station is able to enroll another station with the multicast group through a message exchange or the station is prohibited from enrolling the other station with the multicast group, or receiving a request from the multicast subscriber for a latest multicast schedule, the request received in one of a public action frame and management frame and, in response to reception of the request, send one of a management frame and public action frame with the latest multicast schedule attribute through one of broadcast and unicast to the multicast subscriber.

Example 21 is a non-transitory computer-readable storage medium that stores instructions for execution by one or more processors of a multicast publisher to configure the multicast publisher to: determine a multicast schedule and a multicast schedule candidate for a multicast service in a Neighborhood Awareness Network (NAN), the multicast schedule used to receive data from the multicast publisher for the multicast service, an initiating multicast publisher that initiates the multicast group determines the multicast schedule candidate, time slots of the multicast schedule comprising time slots of a multicast schedule candidate or a subset of the time slots of the multicast schedule candidate; receive a request from a multicast subscriber to join a multicast group associated with a multicast service, the multicast group being one-to-many or many-to-many; transmit a Service Discovery Frame (SDF) to the request to the multicast subscriber, the SDF comprising the multicast schedule; and indicate a multicast schedule selection policy for other multicast publishers to join the multicast group, the multicast schedule selection policy specifying selection of the multicast schedule by the other multicast publishers.

In Example 22, the subject matter of Example 21 optionally includes, wherein the instructions further configure the multicast publisher to: generate one of a multicast schedule attribute or a multicast group attribute of a multicast schedule frame that comprises a unicast/multicast (U/M) bit for the multicast group to indicate whether the multicast schedule is able to be used for a unicast transmission, and schedule the multicast service using the one of the multicast schedule attribute or the multicast group attribute.

In Example 23, the subject matter of Example 22 optionally includes, wherein the instructions further configure the multicast publisher to: receive a request for unicast transmission when the U/M bit indicates that the multicast schedule is able to be used for a unicast transmission, and bypass a unicast schedule setup procedure in response to receiving the request for the unicast transmission.

In Example 24, the subject matter of any one or more of Examples 21-23 optionally include, wherein the instructions further configure the multicast publisher to at least one of: determine multicast schedules for many-to-many multicast groups, the multicast schedules of each of the many-to-many multicast groups dependent on multicast publishers that have joined the many-to-many multicast group and independent of the multicast schedule of other many-to-many multicast groups, coordinate multicast schedules for a plurality of multicast publishers associated with the multicast group to permit a multicast subscriber that is a member of the multicast group to wake up for fewer time slots to receive the multicast service from the plurality of multicast publishers, transmit to another multicast publisher that has requested to join the multicast group an enrollment rule that indicates which is to be followed of: the other multicast publisher is able to enroll another station with the multicast group through a message exchange and the other multicast publisher is prohibited from enrolling the other station with the multicast group, or receive a request from the multicast subscriber for a latest multicast schedule, the request received in one of a public action frame and management frame and, in response to reception of the request, send one of a management frame and public action frame with the latest multicast schedule attribute through one of broadcast and unicast to the multicast subscriber.

In Example 25, the subject matter of any one or more of Examples 21-24 optionally include, wherein: the multicast schedule candidate is included in one of a multicast group attribute and multicast schedule attribute provided by the initiating multicast publisher, a multicast schedule of each multicast publisher that joins the multicast group is selected by the multicast publisher from the multicast schedule candidate dependent on the multicast schedule selection policy, and the multicast schedule selection policy is selected from among at least: to follow the multicast schedule acquired when joining the multicast group, to use the multicast schedule candidate to determine a multicast schedule, and to be free to choose a multicast schedule.

Example 26 is an apparatus of a wireless device configured to operate as a multicast subscriber, the apparatus comprising: a memory; and processing circuitry arranged to: generate a request to a multicast publisher to join a multicast group associated with a multicast service in a Neighborhood Awareness Network (NAN), the multicast group being one-to-many or many-to-many; decode a Service Discovery Frame (SDF) to the request from the multicast publisher, the SDF comprising a multicast schedule to provide data of the multicast service from the multicast publisher, time slots of the multicast schedule comprising time slots of a multicast schedule candidate or a subset of the time slots of the multicast schedule candidate, the multicast schedule coordinated with a multicast schedule of another multicast publisher in the multicast group; and decode the data of the multicast service as indicated by the multicast schedule.

In Example 27, the subject matter of Example 26 optionally includes, wherein the processing circuitry is further arranged to: decode one of a service discovery frame (SDF) or a public action frame comprising a multicast schedule attribute, the multicast schedule attribute comprising an updated multicast schedule for the multicast service.

In Example 28, the subject matter of any one or more of Examples 26-27 optionally include, wherein the processing circuitry is further arranged to: decode one of a multicast schedule attribute or a multicast group attribute of a multicast schedule frame, used to schedule the multicast service, that comprises a unicast/multicast (U/M) bit for the multicast group to indicate whether the multicast schedule is able to be used for a unicast transmission, the U/M bit indicates that the multicast schedule is able to be used for a unicast transmission, generate a request for unicast service for the multicast service, and bypass a unicast schedule setup procedure with the multicast publisher after transmission of the request.

In Example 29, the subject matter of any one or more of Examples 26-28 optionally include, wherein the processing circuitry is further arranged to: decode one of a multicast group attribute or multicast schedule attribute that includes the multicast schedule candidate in the one of the multicast group attribute and multicast schedule attribute, wherein a multicast schedule selection policy in is selected from among at least: to follow the multicast schedule acquired when joining the multicast group, to use the multicast schedule candidate to determine a multicast schedule, and to be free to choose a multicast schedule.

Example 30 is an apparatus of a wireless device configured to operate as a multicast publisher, the apparatus comprising: means for determining a multicast schedule and a multicast schedule candidate for a multicast service in a Neighborhood Awareness Network (NAN), the multicast schedule used to receive data from the multicast publisher for the multicast service, an initiating multicast publisher that initiates the multicast group determines the multicast schedule candidate, time slots of the multicast schedule comprising time slots of a multicast schedule candidate or a subset of the time slots of the multicast schedule candidate; means for receiving a request from a multicast subscriber to join a multicast group associated with a multicast service, the multicast group being one-to-many or many-to-many; means for transmitting a Service Discovery Frame (SDF) to the request to the multicast subscriber, the SDF comprising the multicast schedule; and means for indicating a multicast schedule selection policy for other multicast publishers to join the multicast group, the multicast schedule selection policy specifying selection of the multicast schedule by the other multicast publishers.

In Example 31, the subject matter of Example 30 optionally includes, further comprising: means for generate one of a multicast schedule attribute or a multicast group attribute of a multicast schedule frame that comprises a unicast/multicast (U/M) bit for the multicast group to indicate whether the multicast schedule is able to be used for a unicast transmission, and means for schedule the multicast service using the one of the multicast schedule attribute or the multicast group attribute.

In Example 32, the subject matter of Example 31 optionally includes, further comprising: means for receive a request for unicast transmission when the U/M bit indicates that the multicast schedule is able to be used for a unicast transmission, and means for bypassing a unicast schedule setup procedure in response to receiving the request for the unicast transmission.

In Example 33, the subject matter of any one or more of Examples 30-32 optionally include, further comprising: means for determine multicast schedules for many-to-many multicast groups, the multicast schedules of each of the many-to-many multicast groups dependent on multicast publishers that have joined the many-to-many multicast group and independent of the multicast schedule of other many-to-many multicast groups, means for coordinate multicast schedules for a plurality of multicast publishers associated with the multicast group to permit a multicast subscriber that is a member of the multicast group to wake up for fewer time slots to receive the multicast service from the plurality of multicast publishers, means for transmit to another multicast publisher that has requested to join the multicast group an enrollment rule that indicates which is to be followed of: the other multicast publisher is able to enroll another station with the multicast group through a message exchange and the other multicast publisher is prohibited from enrolling the other station with the multicast group, or means for receive a request from the multicast subscriber for a latest multicast schedule, the request received in one of a public action frame and management frame and, in response to reception of the request, send one of a management frame and public action frame with the latest multicast schedule attribute through one of broadcast and unicast to the multicast subscriber.

In Example 34, the subject matter of any one or more of Examples 30-33 optionally include, wherein: the multicast schedule candidate is included in one of a multicast group attribute and multicast schedule attribute provided by the initiating multicast publisher, a multicast schedule of each multicast publisher that joins the multicast group is selected by the multicast publisher from the multicast schedule candidate dependent on the multicast schedule selection policy, and the multicast schedule selection policy is selected from among at least: to follow the multicast schedule acquired when joining the multicast group, to use the multicast schedule candidate to determine a multicast schedule, and to be free to choose a multicast schedule.

Example 35 is an apparatus of a wireless device configured to operate as a multicast subscriber, the apparatus comprising: means for generating a request to a multicast publisher to join a multicast group associated with a multicast service in a Neighborhood Awareness Network (NAN), the multicast group being one-to-many or many-to-many; means for decoding a Service Discovery Frame (SDF) to the request from the multicast publisher, the SDF comprising a multicast schedule to provide data of the multicast service from the multicast publisher, time slots of the multicast schedule comprising time slots of a multicast schedule candidate or a subset of the time slots of the multicast schedule candidate, the multicast schedule coordinated with a multicast schedule of another multicast publisher in the multicast group; and means for decoding the data of the multicast service as indicated by the multicast schedule.

In Example 36, the subject matter of Example 35 optionally includes, wherein the processing circuitry is further arranged to: means for decoding one of a service discovery frame (SDF) or a public action frame comprising a multicast schedule attribute, the multicast schedule attribute comprising an updated multicast schedule for the multicast service.

In Example 37, the subject matter of any one or more of Examples 35-36 optionally include, wherein the processing circuitry is further arranged to: means for decoding one of a multicast schedule attribute or a multicast group attribute of a multicast schedule frame, used to schedule the multicast service, that comprises a unicast/multicast (U/M) bit for the multicast group to indicate whether the multicast schedule is able to be used for a unicast transmission, the U/M bit indicates that the multicast schedule is able to be used for a unicast transmission, means for generating a request for unicast service for the multicast service, and means for bypassing a unicast schedule setup procedure with the multicast publisher after transmission of the request.

In Example 38, the subject matter of any one or more of Examples 35-37 optionally include, wherein the processing circuitry is further arranged to: means for decoding one of a multicast group attribute or multicast schedule attribute that includes the multicast schedule candidate in the one of the multicast group attribute and multicast schedule attribute, wherein a multicast schedule selection policy in is selected from among at least: to follow the multicast schedule acquired when joining the multicast group, to use the multicast schedule candidate to determine a multicast schedule, and to be free to choose a multicast schedule.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1. An apparatus of a wireless device configured to operate as a multicast publisher, the apparatus comprising:
a memory; and
processing circuitry arranged to:
initiate a multicast group for a multicast service in a Neighborhood Awareness Network (NAN), the multicast group being a one-to-many or many-to-many multicast group;
establish a multicast schedule and a multicast schedule candidate for the multicast service, time slots of the multicast schedule being at least a subset of time slots of the multicast schedule candidate;
coordinate multicast schedules of other multicast publishers in the multicast group;
decode a request from a multicast subscriber to join the multicast group;
generate a Service Discovery Frame (SDF) in response to the request to the multicast subscriber, the SDF comprising a multicast schedule to provide data of the multicast service from the multicast publisher.

2. The apparatus of claim 1, wherein the processing circuitry is further arranged to:
maintain the multicast group after initiation of the multicast group.

3. The apparatus of claim 1, wherein the processing circuitry is further arranged to:
initiate multiple multicast groups; and
maintain a multicast schedule of each of the multicast groups.

4. The apparatus of claim 1, wherein the processing circuitry is further arranged to:
update the multicast schedule via transmission of one of a service discovery frame (SDF) or public action frame for a schedule update broadcast comprising a multicast schedule attribute.

5. The apparatus of claim 1, wherein the processing circuitry is further arranged to:
generate one of a multicast schedule attribute or a multicast group attribute of a multicast schedule frame, used to schedule the multicast service, that comprises a unicast/multicast (U/M) bit for the multicast group to indicate whether the multicast schedule is able to be used for a unicast transmission.

6. The apparatus of claim 5, wherein:
the U/M bit indicates that the multicast schedule is able to be used for a unicast transmission, and
the processing circuitry is further arranged to:
decode a request for unicast service for the multicast service from a unicast subscriber, and
in response to the request, bypass a unicast schedule setup procedure for the unicast subscriber.

7. The apparatus of claim 6, wherein the processing circuitry is further arranged to:
generate multicast traffic for the multicast service directed to the multicast subscriber simultaneously with generation of unicast traffic for the unicast subscriber.

8. The apparatus of claim 1, wherein the processing circuitry is further arranged to:
initiate multiple many-to-many multicast groups;
decode a request to join one of the many-to-many multicast groups from at least one multicast publisher; and
control a multicast schedule of each of the many-to-many multicast groups.

9. The apparatus of claim 8, wherein the processing circuitry is further arranged to:
determine multicast schedules for the many-to-many multicast groups, the multicast schedules of each of the many-to-many multicast groups dependent on multicast publishers that have joined the many-to-many multicast group and independent of the multicast schedule of multicast publishers of other many-to-many multicast groups.

10. The apparatus of claim 1, wherein the processing circuitry is further arranged to:
coordinate multicast schedules for a plurality of multicast publishers associated with the multicast group to permit a multicast subscriber that is a member of the multicast group to wake up for fewer time slots to receive the multicast service from the plurality of multicast publishers.

11. The apparatus of claim 10, wherein the processing circuitry is further arranged to:
permit another multicast publisher that joins the multicast group to select a multicast schedule from the time slots of the multicast schedule candidate.

12. The apparatus of claim 1, wherein the processing circuitry is further arranged to:
generate one of a multicast group attribute or multicast schedule attribute that includes the multicast schedule candidate in the one of the multicast group attribute and multicast schedule attribute,
wherein the one of a multicast schedule attribute or multicast group attribute comprises a multicast schedule selection policy selected from among at least: to follow the multicast schedule acquired when joining the multicast group, to determine a multicast schedule from the multicast schedule candidate, and to be free to choose a multicast schedule.

13. The apparatus of claim 1, wherein the processing circuitry is further arranged to:
indicate to a station that has requested to join the multicast group an enrollment rule that indicates which is to be followed of: the station is able to enroll another station with the multicast group through a message exchange or the station is prohibited from enrolling the other station with the multicast group.

14. The apparatus of claim 1, wherein the processing circuitry is further arranged to:
decode a request from the multicast subscriber for a latest multicast schedule, the request received in one of a public action frame or management frame; and
in response to reception of the request, generate one of another management frame or public action frame with the latest multicast schedule attribute through one of a broadcast message or a unicast message to the multicast subscriber.

15. The apparatus of claim 1, further comprising:
an antenna configured to transmit to and receive transmissions from the multicast subscriber and other multicast publishers.

16. A method of providing multicast communications, the method comprising:
determining a multicast schedule for a multicast service in a Neighborhood Awareness Network (NAN), the multicast schedule used to receive data from a multicast publisher for the multicast service, time slots of the multicast schedule comprising time slots of a multicast schedule candidate or a subset of the time slots of the multicast schedule candidate;
receiving a request from a multicast subscriber to join a multicast group associated with a multicast service, the multicast group being one-to-many or many-to-many;
transmitting a Service Discovery Frame (SDF) in response to the request to the multicast subscriber, the SDF comprising the multicast schedule.

17. The method of claim 16, further comprising:
generating one of a multicast schedule attribute or a multicast group attribute of a multicast schedule frame that comprises a unicast/multicast (U/M) bit for the multicast group to indicate whether the multicast schedule is able to be used for a unicast transmission; and
scheduling the multicast service using the one of the multicast schedule attribute or the multicast group attribute.

18. The method of claim 17, further comprising:
receiving a request for unicast transmission when the U/M bit indicates that the multicast schedule is able to be used for a unicast transmission; and
bypassing a unicast schedule setup procedure in response to receiving the request for the unicast transmission.

19. The method of claim 16, at least one of:
the method further comprises at least one of:
setting multicast schedules for many-to-many multicast groups, the multicast schedules of each of the many-to-many multicast groups dependent on multicast publishers that have joined the many-to-many multicast group and independent of the multicast schedule of other many-to-many multicast groups, or
coordinating multicast schedules for a plurality of multicast publishers associated with the multicast group to permit a multicast subscriber that is a member of the multicast group to wake up for fewer time slots to receive the multicast service from the plurality of multicast publishers; or
an initiating multicast publisher that initiates the multicast group determines the multicast schedule candidate, the multicast schedule candidate is included in one of a multicast group attribute and multicast schedule attribute provided by the initiating multicast publisher, and a multicast schedule of each multicast publisher that joins the multicast group is selected by the multicast publisher from the multicast schedule candidate dependent on a multicast schedule selection policy, the multicast schedule selection policy selected from among at least: to follow the multicast schedule acquired when joining the multicast group, to use the multicast schedule candidate to determine a multicast schedule, and to be free to choose a multicast schedule.

20. The method of claim 16, further comprising at least one of:
transmitting to a station that has requested to join the multicast group an enrollment rule that indicates which is to be followed of: the station is able to enroll another station with the multicast group through a message exchange or the station is prohibited from enrolling the other station with the multicast group, or
receiving a request from the multicast subscriber for a latest multicast schedule, the request received in one of a public action frame and management frame and, in response to reception of the request, send one of a management frame and public action frame with the latest multicast schedule attribute through one of broadcast and unicast to the multicast subscriber.

21. A non-transitory computer-readable storage medium that stores instructions for execution by one or more processors of a multicast publisher to configure the multicast publisher to:
determine a multicast schedule and a multicast schedule candidate for a multicast service in a Neighborhood Awareness Network (NAN), the multicast schedule used to receive data from the multicast publisher for the multicast service, an initiating multicast publisher that initiates the multicast group determines the multicast schedule candidate, time slots of the multicast schedule comprising time slots of a multicast schedule candidate or a subset of the time slots of the multicast schedule candidate;
receive a request from a multicast subscriber to join a multicast group associated with a multicast service, the multicast group being one-to-many or many-to-many;
transmit a Service Discovery Frame (SDF) to the request to the multicast subscriber, the SDF comprising the multicast schedule; and
indicate a multicast schedule selection policy for other multicast publishers to join the multicast group, the multicast schedule selection policy specifying selection of the multicast schedule by the other multicast publishers.

22. The medium of claim 21, wherein the instructions further configure the multicast publisher to:
generate one of a multicast schedule attribute or a multicast group attribute of a multicast schedule frame that comprises a unicast/multicast (U/M) bit for the multicast group to indicate whether the multicast schedule is able to be used for a unicast transmission, and
schedule the multicast service using the one of the multicast schedule attribute or the multicast group attribute.

23. The medium of claim 22, wherein the instructions further configure the multicast publisher to:
receive a request for unicast transmission when the U/M bit indicates that the multicast schedule is able to be used for a unicast transmission, and
bypass a unicast schedule setup procedure in response to receiving the request for the unicast transmission.

24. The medium of claim 21, wherein the instructions further configure the multicast publisher to at least one of:
determine multicast schedules for many-to-many multicast groups, the multicast schedules of each of the many-to-many multicast groups dependent on multicast publishers that have joined the many-to-many multicast group and independent of the multicast schedule of other many-to-many multicast groups,
coordinate multicast schedules for a plurality of multicast publishers associated with the multicast group to permit a multicast subscriber that is a member of the multicast group to wake up for fewer time slots to receive the multicast service from the plurality of multicast publishers,
transmit to another multicast publisher that has requested to join the multicast group an enrollment rule that indicates which is to be followed of: the other multicast publisher is able to enroll another station with the multicast group through a message exchange and the other multicast publisher is prohibited from enrolling the other station with the multicast group, or
receive a request from the multicast subscriber for a latest multicast schedule, the request received in one of a public action frame and management frame and, in response to reception of the request, send one of a management frame and public action frame with the latest multicast schedule attribute through one of broadcast and unicast to the multicast subscriber.

25. The medium of claim 21, wherein:
the multicast schedule candidate is included in one of a multicast group attribute and multicast schedule attribute provided by the initiating multicast publisher,
a multicast schedule of each multicast publisher that joins the multicast group is selected by the multicast publisher from the multicast schedule candidate dependent on the multicast schedule selection policy, and
the multicast schedule selection policy is selected from among at least: to follow the multicast schedule acquired when joining the multicast group, to use the multicast schedule candidate to determine a multicast schedule, and to be free to choose a multicast schedule.

26. An apparatus of a wireless device configured to operate as a multicast subscriber, the apparatus comprising:
a memory; and
processing circuitry arranged to:
generate a request to a multicast publisher to join a multicast group associated with a multicast service in a Neighborhood Awareness Network (NAN), the multicast group being one-to-many or many-to-many;
decode a Service Discovery Frame (SDF) to the request from the multicast publisher, the SDF comprising a multicast schedule to provide data of the multicast service from the multicast publisher, time slots of the multicast schedule comprising time slots of a multicast schedule candidate or a subset of the time slots of the multicast schedule candidate, the multicast schedule coordinated with a multicast schedule of another multicast publisher in the multicast group; and
decode the data of the multicast service as indicated by the multicast schedule.

27. The apparatus of claim 26, wherein the processing circuitry is further arranged to:
decode one of a service discovery frame (SDF) or a public action frame comprising a multicast schedule attribute, the multicast schedule attribute comprising an updated multicast schedule for the multicast service.

28. The apparatus of claim 26, wherein the processing circuitry is further arranged to:
decode one of a multicast schedule attribute or a multicast group attribute of a multicast schedule frame, used to schedule the multicast service, that comprises a unicast/multicast (U/M) bit for the multicast group to indicate whether the multicast schedule is able to be used for a unicast transmission, the U/M bit indicates that the multicast schedule is able to be used for a unicast transmission,
generate a request for unicast service for the multicast service, and
bypass a unicast schedule setup procedure with the multicast publisher after transmission of the request.

29. The apparatus of claim 26, wherein the processing circuitry is further arranged to:
decode one of a multicast group attribute or multicast schedule attribute that includes the multicast schedule candidate in the one of the multicast group attribute and multicast schedule attribute,
wherein a multicast schedule selection policy in is selected from among at least: to follow the multicast schedule acquired when joining the multicast group, to use the multicast schedule candidate to determine a multicast schedule, and to be free to choose a multicast schedule.
